(19) United States
(12) Patent Application Publication
(10) Pub. No.: US 2004/0247185 A1
(43) Pub. Date: Dec. 9, 2004

(54) Image processing apparatus and image processing method

(76) Inventors: Yutaka Sato, Osaka (JP); Mitsutaka Iwasaki, Kanagawa (JP); Yukio Kadowaki, Nara (JP)

Correspondence Address: COOPER & DUNHAM, LLP, 1185 AVENUE OF THE AMERICAS, NEW YORK, NY, 10036

(21) Appl. No.: 10/494,713

(22) PCT Filed: Jun. 6, 2002
(86) PCT No.: PCT/JP03/07204

(30) Foreign Application Priority Data
Jun. 27, 2002 (JP) 2002-187547

(51) Int. Cl. G06K 9/36

(52) U.S. Cl. 382/232

(57) ABSTRACT

An image processing apparatus is provided that has a smaller circuit size and flexibly copes with applications having various amounts of additional information. This image processing apparatus that produces data having the additional information added to the encoded data of an image includes: a data processing unit that produces data having a data write area for writing a desired amount of data of the additional information at a predetermined spot in the encoded data of the image; and a data correction unit that writes the data of the additional information in the data write area in the data produced by the data processing unit.

### FIELD OF THE INVENTION

The present invention relates to an image processing apparatus that produces data having information as to encoding and other information, such as the additional information of each application, added to encoded data, when image data are compressed and encoded. The present invention also relates to an image processing method utilized by such an image processing apparatus.

### BACKGROUND OF THE INVENTION

Conventionally, image processing apparatuses that produce data having information as to encoding and other information, such as the additional information of each application, added to encoded data, when image data are compressed and encoded are widely known.

In the following, an apparatus that performs an image compressing process in accordance with the JPEG-2000 standard will be described as an example of a conventional apparatus. FIG. 10 illustrates the structure of an image processing apparatus B that includes a standard encoding device 100 that performs an image compressing process in accordance with the JPEG-2000 standard. In this apparatus, a CPU 1 and a memory 2 are connected to the encoding device 100 via a data bus 3. When image data are compressed and encoded, the CPU 1 reads the image data from an original, and inputs the image data into the encoding device 100 via the data bus 3.

The encoding device 100 includes an encoding unit 101 that performs encoding in accordance with the JPEG-2000 standard, and a code forming unit 102 that adds information as to the encoding and additional information as to the application in use to the data encoded by the encoding unit 101, and thereby produces ultimate encoded data (or data that are called a code stream in JPEG-2000 encoding processes).

To avoid confusion, the data encoded by the encoding unit 101 will be hereinafter referred to simply as the “encoded data”, and the ultimate encoded data having the additional information added to the encoded data will be referred to as the “encoded data (code stream)”.

As shown in FIG. 10, the code forming unit 102 includes an encoded data buffer 103 that temporarily stores encoded data output from the JPEG-2000 encoding unit 101, an encoding parameter buffer 104 that stores information as to encoding (the setting data) output from the CPU 1 via the data bus 3, a COM buffer 105 that stores the additional information produced by the application in use, and a data producing unit 106 that outputs a data read request signal to the above three buffers when necessary, reads necessary data, and produces the encoded data (code stream).

FIG. 11 illustrates the structure of the encoded data (code stream) output from the data producing unit 106. In accordance with the JPEG-2000 standard, image data of each original image are divided into blocks called tiles that are formed by predetermined pixel matrixes. The encoded data (code stream) output from the data producing unit 106 are made up of a main header, the header of the first tile, the encoded data of the first tile, the header of the second tile, the encoded data of the second tile, . . . , the header of the Nth tile, and the encoded data of the Nth tile. In a JPEG-2000 encoding process, a COM marker segment for adding the additional information of the application in use, as well as the information as to the encoding, is allocated to the main header.

In accordance with the JPEG-2000 standard, the data amount of additional information prepared by the application in use is not particularly limited. To cope with the various sizes of additional information prepared by the application in use, it is necessary to employ the large-capacity COM buffer 105 that can store the greatest possible amount of additional information. However, with such a large-capacity buffer, the circuit size becomes very large.

### DISCLOSURE OF THE INVENTION

Therefore, a general object of the present invention is to provide an image processing apparatus and an image processing method in which the above disadvantages are eliminated.

A more specific object of the present invention is to provide an image processing apparatus that outputs data including encoded data having information as to encoding and other information, such as the data of additional information produced by the application in use, added to the encoded data. This type of image processing apparatus can prevent an increase of circuit size, and cope with applications having various amounts of additional information.

The above objects of the present invention are achieved by an image processing apparatus that produces data having encoded data of an image and additional information added to the encoded data. This image processing apparatus includes: a data processing unit that produces data having a data write area added for writing data of a desired amount of additional information at a predetermined spot in the encoded data of the image; and a data correction unit that writes the data of the additional information in the data write area in the data produced by the data processing unit.

The above image processing apparatus may further include a buffer memory for storing the additional information. In this image processing apparatus, the data processing unit produces the data having the data write area for writing the data of the additional information at the predetermined spot in the encoded data of the image, when the data amount of the additional information to be added to the encoded data exceeds the capacity of the buffer memory. When the data amount of the additional information to be added to the encoded data is within the capacity of the buffer memory, the data processing unit temporarily stores the data of the additional information in the buffer memory, and then produces data having the data of the additional information stored in the buffer memory at the predetermined spot in the encoded data of the image. As for the data correction unit, when the data amount of the additional information to be added to the encoded data exceeds the capacity of the buffer memory, the data correction unit writes the data of the additional information in the data write area in the data formed by the data processing unit. When the data amount of the additional information to be added to the encoded data is within the capacity of the buffer memory, the data correction unit outputs the data produced by the data processing unit without any correction.

The above objects of the present invention are also achieved by an image processing method of forming data having encoded data of an image and additional information added to the encoded data. This method includes the steps of: producing data having a data write area for writing the data of a desired amount of additional information at a predetermined spot in the encoded data of the image; and performing data correction by writing the data of the additional information in the data write area in the data produced in the data producing step.

In this image processing method, the data producing step may include, when the data amount of the additional information to be added to the encoded data exceeds the capacity of a buffer memory employed for storing the data of the additional information, producing the data having the data write area for writing the data of the additional information at the predetermined spot in the encoded data of the image, and, when the data amount of the additional information to be added to the encoded data is within the capacity of the buffer memory, temporarily storing the data of the additional information in the buffer memory, and then producing data including the data of the additional information stored in the buffer memory at the predetermined spot in the encoded data of the image. The data correcting step may include, when the data amount of the additional information to be added to the encoded data exceeds the capacity of the buffer memory, writing the data of the additional information in the data write area in the data produced in the data producing step, and, when the data amount of the additional information to be added to the encoded data is within the capacity of the buffer memory, outputting the data produced in the data producing step without any correction.

The above and other objects, features, and advantages of the present invention will become more apparent from the following detailed description taken in conjunction with the accompanying drawings.

### BRIEF DESCRIPTION OF THE DRAWINGS

FIG. 1 illustrates the structure of an image processing apparatus in accordance with one embodiment of the present invention;

FIG. 2 illustrates the structure of one set of encoded data (code stream) generated by the image processing apparatus;

FIG. 3 shows the types (marker segments) of the additional information included in the encoded data (code stream) and parameters contained therein;

FIG. 4 illustrates an example of the main header of the encoded data (code stream);

FIG. 5 illustrates the structure of the code forming unit of the image processing apparatus;

FIG. 6 illustrates the structure of the COM buffer circuit of the code forming unit of FIG. 5;

FIG. 7 illustrates the structure of the data correction unit of the image processing apparatus of FIG. 1;

FIG. 8 is a flowchart of an operation performed by the CPU shown in FIG. 5:

FIG. 9 illustrates the structure of the COM buffer circuit in another embodiment of the present invention;

FIG. 10 illustrates the structure of a conventional image processing apparatus; and

FIG. 11 illustrates the structure of encoded data (code stream) generated by the conventional image processing apparatus of FIG. 10.

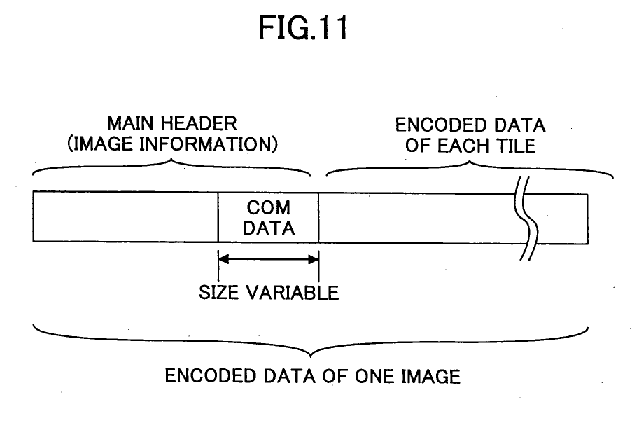

### PREFERRED EMBODIMENTS FOR CARRYING OUT THE INVENTION

### (1) Principles

The following is a description of embodiments of image processing apparatuses in accordance with the present invention, with reference to the accompanying drawings.

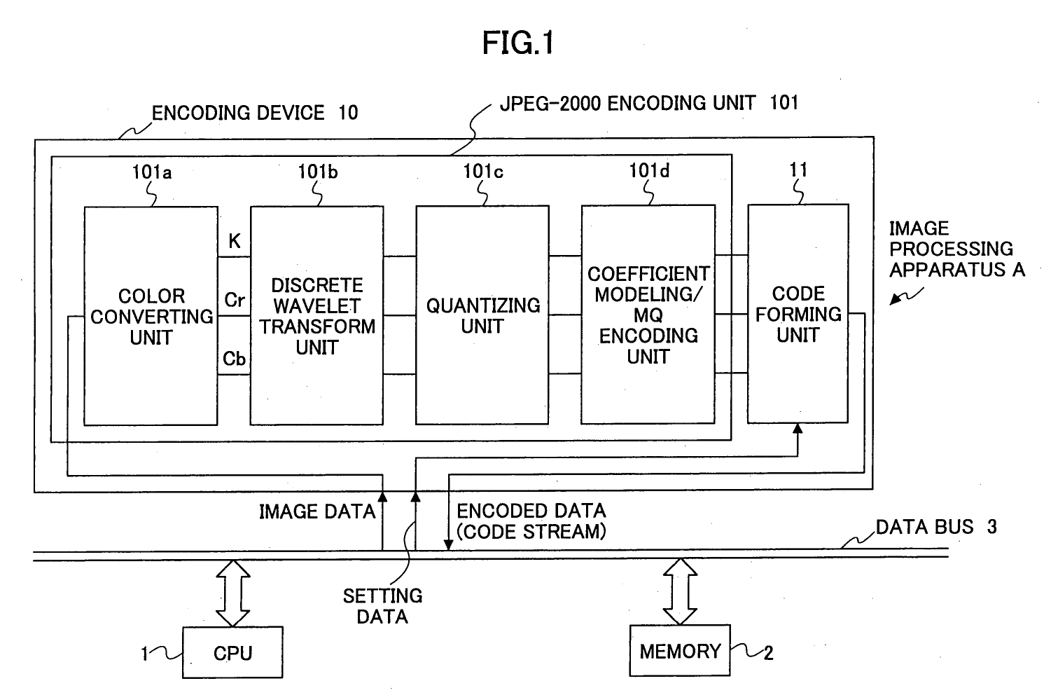

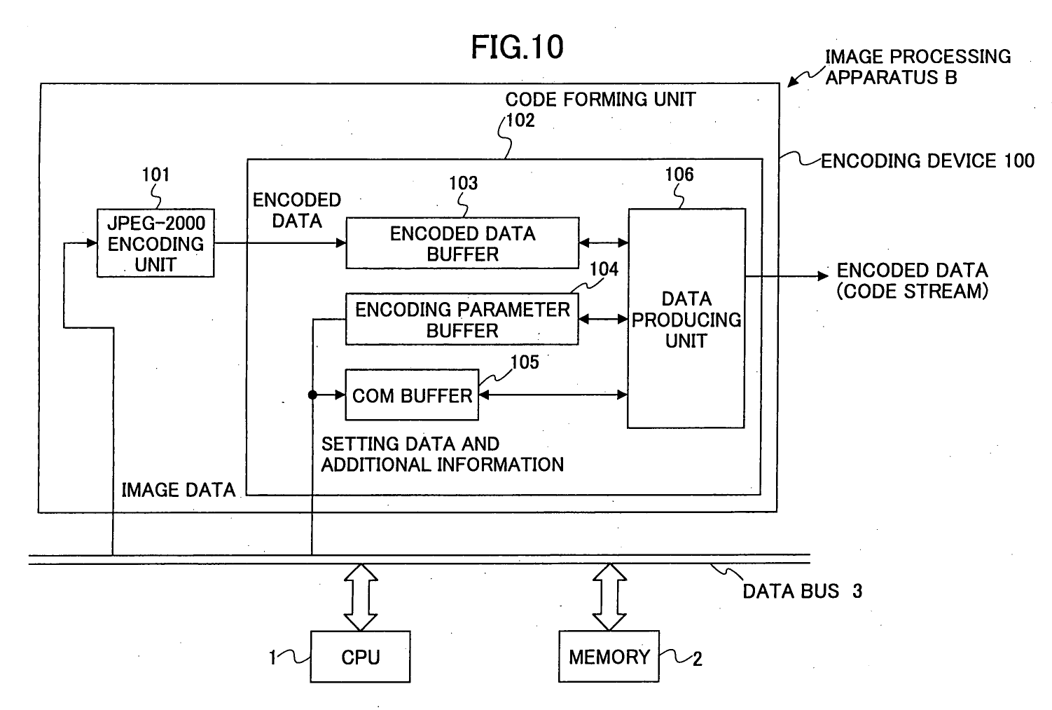

FIG. 1 illustrates the entire structure of an image processing apparatus A as an embodiment of the present invention. This image processing apparatus A produces data having information as to encoding and other information, such as the additional information of each application, added to encoded data, when image data are compressed and encoded in accordance with the JPEG-2000 standard. In FIG. 1, the same components as the corresponding components of the image processing apparatus B described as the prior art are denoted by the same reference numerals as the corresponding reference numerals in FIG. 10.

In this image processing apparatus, a CPU 1 and a memory 2 are connected to an encoding device 10 via a data bus 3. The CPU 1 reads image data of an original from the memory 2, and inputs the image data into the encoding device 10 via the data bus 3.

The encoding device 10 includes an encoding unit 101 that performs JPEG-2000 encoding, and a code forming unit 11 that adds encoding information (or the setting data) and additional information produced by the application in use to a predetermined spot in the data (image encoded data) encoded by the encoding unit 101, and creates ultimate encoded data (a so-called code stream used in the JPEG-2000 encoding process).

To avoid confusion, the data encoded by the encoding unit 101 will be hereinafter referred to simply as the “encoded data”, and the ultimate encoded data will be referred to as the “encoded data (code stream)”.

The encoding unit 101 has a structure compliant with the JPEG-2000 standard. After a color converting unit 101a converts input image data into three signals of Y (brightness), Cr (color difference), and Cb (color difference), a discrete wavelet transform unit 101b performs discrete wavelet transformation. A quantizing unit 101c performs entropy quantization, and a coefficient modeling/MQ encoding unit 101d performs bit-plane conversion for each block of a predetermined size. Encoding is then performed by a 3-bus technique.

### (2) Encoded Data (Code Stream)

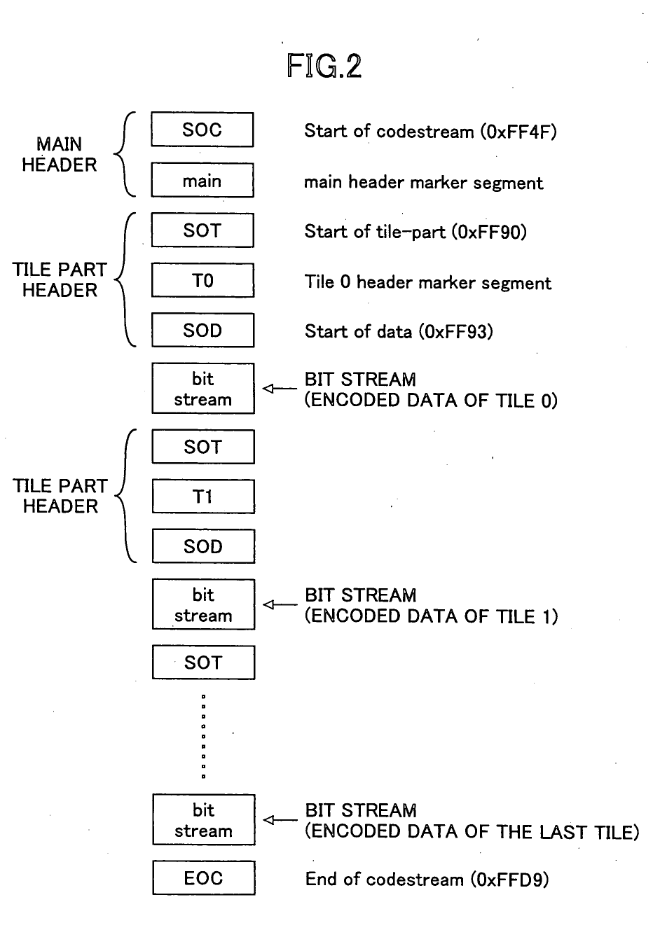

FIG. 2 illustrates the structure of the encoded data (code stream) formed by the code forming unit 11 in compliance with the JPEG-2000 standard. The encoded data (code stream) includes a main header (consisting of the encoding information and the additional information), two or more sets of tile part headers (containing the encoding information), and bit streams (the encoded data of the last tile) each following the corresponding set of tile part headers.

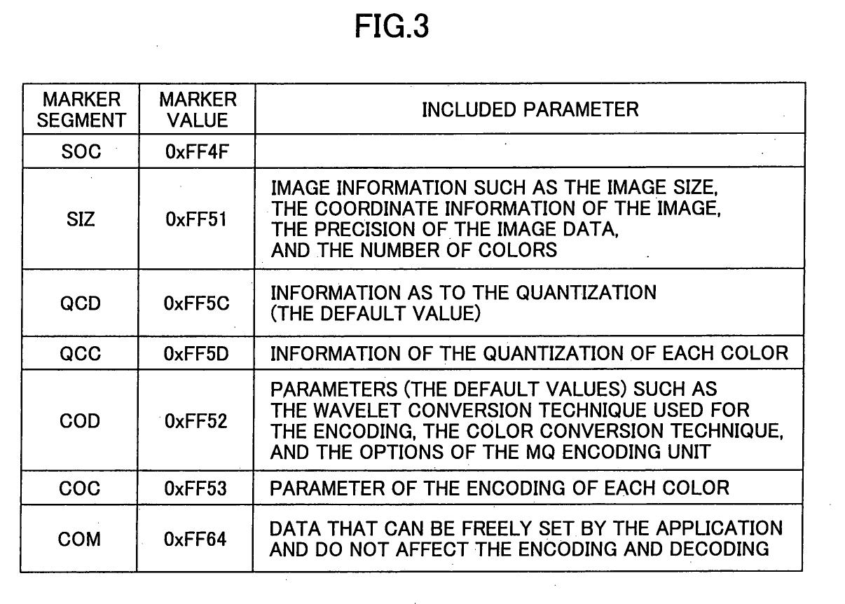

The main header is located only at the top of one set of encoded data (a code stream), and mainly contains the information as to the encoding such as the size of the image, the number of colors used in the image, the operation parameters used for the compression, and the additional information produced by the application in use. More specifically, the main header contains data (0×FF4F) labeled “SOC” (start of code stream) and data of marker segments labeled “main” (main header marker segments). The data of the marker segments labeled “main” will be described later in detail, with reference to FIG. 3.

In accordance with the JPEG-2000 standard, each image is divided into blocks called “tiles” each formed by a predetermined image matrix. Each of the tile part headers includes information indicating the location and the size of the corresponding tile. Each of the bit streams is the encoded data of the tile specified by the corresponding tile part header, and is generated from the JPEG-2000 encoding unit 101. More specifically, the first one (or number 0) of the tile part headers includes data (0×FF90) labeled “SOT” (start of tile part), data labeled “T0” (Tile 0 header marker segment), and data (0×FF93) labeled “SOD” (start of data). The tile part header of number 0 is followed by the encoded data (bit stream) of the tile of number 0.

At the end of each set of encoded data (code stream), data (0×FFD9) labeled “EOC” (end of code stream) are provided.

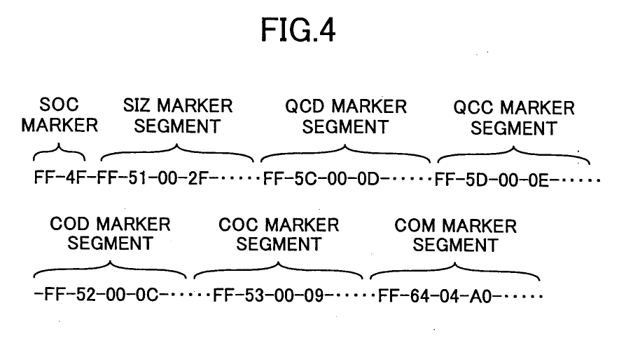

FIG. 3 shows the contents of the main header of FIG. 2. The marker segments labeled “main” in the main header include labels “SIZ”, “QCD”, “QCC”, “COD”, “COC”, and “COM”. Each of the marker segments is formed by a marker value and a data string that indicates the corresponding parameter. FIG. 4 illustrates the contents of the encoded data (code stream) of a main header formed in the format shown in FIG. 3.

As shown in the bottom row of FIG. 3, the marker segment labeled “COM” (hereinafter referred to as the “COM marker segment”) represents data that can be freely set depending on the application in use or the like in accordance with the JPEG-2000 standard. This COM marker segment does not affect encoding/decoding in any way. Accordingly, the JPEG-2000 image processing apparatus A of this embodiment stores the additional information produced by the application that is being used in the COM marker segment.

### (3) Structure of the Code Forming Unit

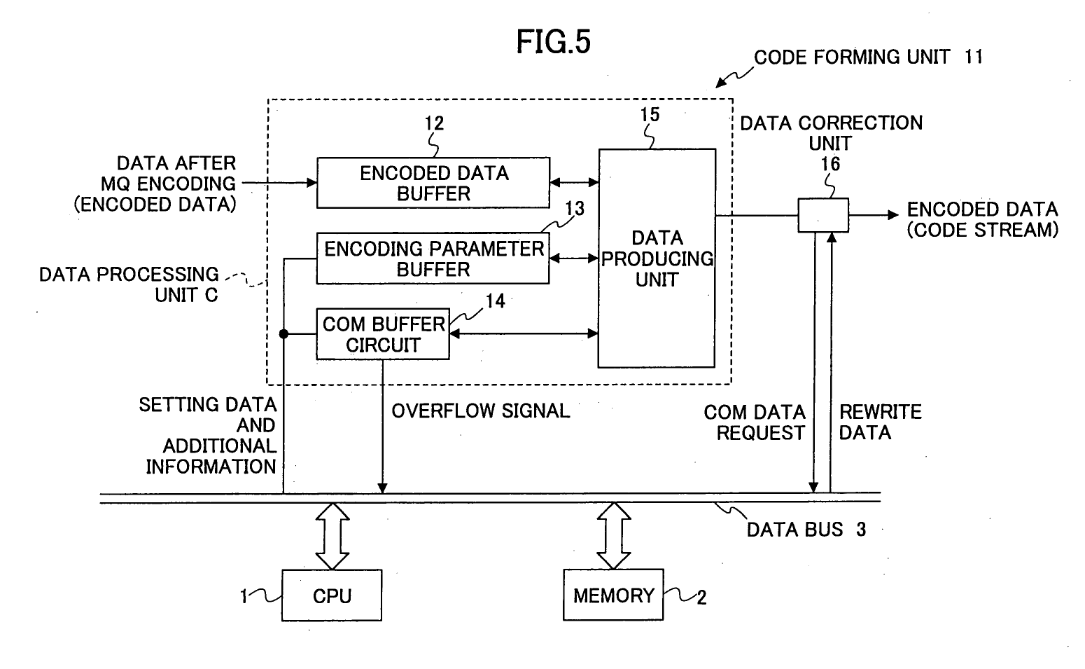

FIG. 5 illustrates the structure of the code forming unit 11. The code forming unit 11 includes an encoded data buffer 12 that temporarily stores encoded data output from the JPEG-2000 encoding unit 101 after MQ encoding, an encoding parameter buffer 13 that stores information as to the marker segments other than the COM marker segment, a COM buffer circuit 14 that stores information as to the COM marker segment, a data producing unit 15 that outputs a read request for reading data from the three foregoing buffers, and reads necessary information to form the encoded data (code stream) of the structure shown in FIG. 2, and a data correction unit 16 that corrects the data of the COM marker segment in the encoded data on predetermined occasions.

The COM buffer circuit 14 has a buffer memory that can store the additional information of the most common size. As will be described later in greater detail, the COM buffer circuit 14 outputs an overflow signal to the CPU 1, if the data amount of the additional information to be input is greater than the predetermined value (the most common size). When data are read from the data producing unit 15 and a request signal is input, the COM buffer circuit 14 outputs the stored amount of data as COM data. Instead of the amount of overflow data, the COM buffer circuit 14 outputs “00” data, and secures the area for writing the data equivalent to the amount of the additional information in the encoded data (code stream).

With the COM buffer circuit 14, the three buffers 12, 13, and 14, and the data producing unit 15 can function as a data processing unit C (shown by the dotted line in FIG. 5) that forms a series of data having a data write area necessary for adding the predetermined amount of additional information data produced by the application in use, to the predetermined spot, i.e., the COM marker segment in the encoded data (the image encoded data) output from the JPEG-2000 encoding unit 101 after the MQ encoding.

As will be described later in detail, the data correction unit 16 operates if the COM buffer circuit 14 outputs an overflow signal. More specifically, the data correction unit 16 rewrites the COM marker segment with correct data in the encoded data (code stream) output from the data producing unit 15.

### (4) Buffer Circuit

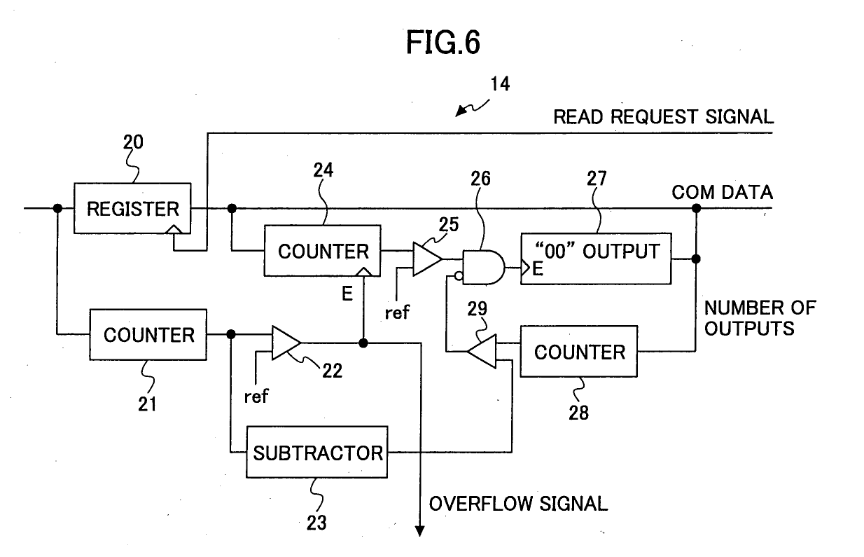

FIG. 6 illustrates the structure of the buffer circuit 14. As will be described later, a counter 21 and a comparator 22 in the buffer circuit 14 function as an overflow detecting circuit that generates an overflow signal, if the data amount of additional information to be input exceeds the largest possible data amount that a register 20 can store.

If an overflow signal is generated, the counter 21, a subtractor 23, a counter 24, a comparator 25, an AND gate 26, a “00” output register 27, a counter 28, and a comparator 29 function as a data supplementing circuit that outputs “00” data, instead of the amount of overflow data of the additional information to be input, to the data producing unit 15.

The structure of the buffer circuit 14 will be described. The additional information data produced by the application in use and output from the CPU 1 via the data bus 3 are first input to the register 20 and the counter 21. A register of a size that can store the most common amount of additional information is employed as the register 20. The most common data amount is determined based on statistical values. However, the size of the register 20 is not limited to the above size, and a register of a smaller size may be employed in favor of a smaller circuit size. The counter 21 measures the data amount of additional information input to the register 20. The comparator 22 outputs an overflow signal of the high level to the CPU 1 via the data. bus 3, if the amount of data measured by the counter 21 is greater than the largest possible amount of data that the register 20 can store. The comparator 22 also outputs the overflow signal to the enable terminal of the counter 24.

The counter 21 also outputs the count value to the subtractor 23. The subtractor 23 subtracts the largest possible amount of data that the register 20 can store from the input count value, and outputs the obtained value to one of the signal input terminals of the comparator 29.

When a high-level data read request is input to the enable terminal of the register 20 from the data producing unit 15, the register 20 outputs the stored additional information data as the COM data to the data producing unit 15. Here, the counter 24 measures the amount of the output COM data, and outputs the obtained count value to one of the signal input terminals of the comparator 25. If the count value indicates an amount that can be stored in the register 20, the comparator 25 outputs a high-level signal to one of the signal input terminals of the AND gate 26. The output signal of the comparator 29 is inversely input to the other one of the signal input terminals of the AND gate 26. If the output of the comparator 29 is at the low level, the AND gate 26 outputs a high-level signal to the enable terminal of the “00” output register 27. Upon receipt of the high-level signal at the enable terminal, the “00” output register 27 repeatedly outputs “00” at predetermined timings. The counter 28 counts the number of “00”s output from the “00” output register 28, and outputs the obtained count value to the comparator 29. If the number of “00”s is equivalent to the overflow data, the comparator 29 outputs a high-level signal, switches the output of the AND gate 26 to the low level, and stops the operation of the “00” output register 27.

If the comparator 22 does not output a high-level overflow signal, the counter 24 is not activated. Accordingly, the operation of supplementing “00”s, is not performed, and the additional information stored in the register 20 is output as the COM data to the data producing unit 15.

### (5) Data Correction Unit

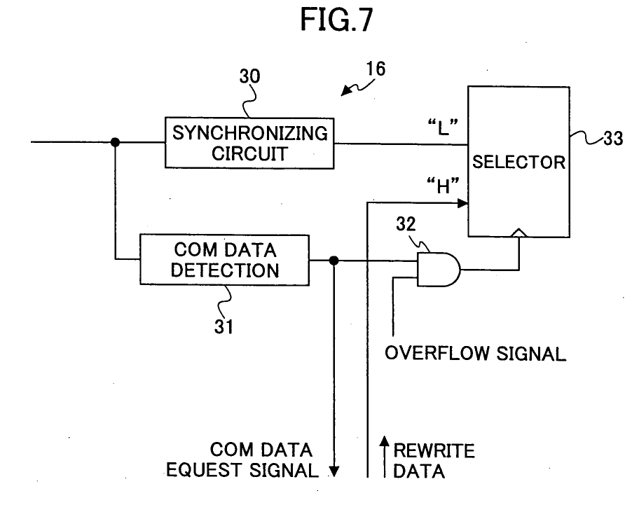

FIG. 7 illustrates the structure of the data correction unit 16. The encoded data (code stream) generated from the data producing unit 15 is input to a synchronizing circuit 30 and a COM data detecting circuit 31. The COM data detecting circuit 31 detects “0×FF64” representing the COM marker segment from the encoded data (code stream), and outputs a high-level COM-data request signal to the CPU 1. Upon receipt of the COM-request signal, the CPU 1 outputs COM data as rewrite data to a selector 33. A low-level signal is normally input from an AND gate 32 to the selector signal input terminal of the selector 33, and the encoded data (code stream) input via the synchronizing circuit 30 are output without any correction. The AND gate 32 outputs a high-level signal only when a high-level overflow signal and a high-level COM-data request signal are input. In such a case, the selector 33 outputs the rewrite data supplied from the CPU 1, instead of the COM data of the encoded data. The synchronizing circuit 30 may be, for example, formed by inverter elements connected in series, and perform timing adjustment so that the rewrite data supplied from the CPU 1 can be replaced by the corresponding data contained in the encoded data (code stream).

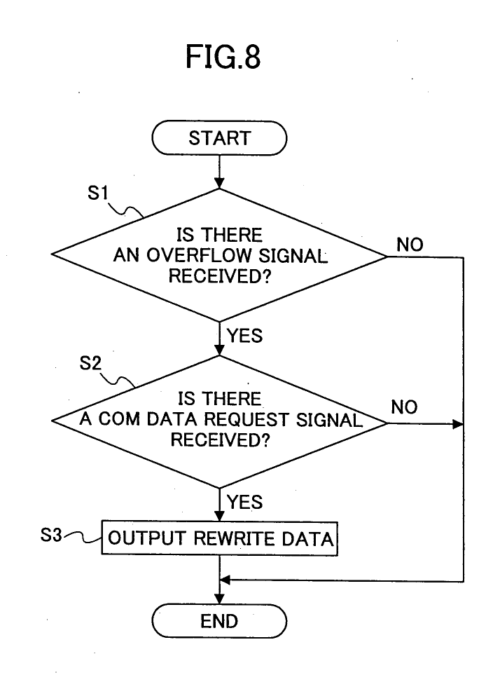

FIG. 8 is a flowchart of the data rewrite operation performed by the CPU 1. Receiving a high-level overflow signal from the COM buffer circuit 14 (“YES” in step S1) and a high-level COM-data request signal from the data correction unit 16 (“YES” in step S2), the CPU 1 outputs all of the correct COM data as rewrite data to the data correction unit 16 (step S3). If neither a high-level overflow signal nor a high-level COM-data request signal is received, the operation simply comes to an end, without rewrite data output.

As described above, if the data amount of the additional information produced by the application in use is too large in the image processing apparatus A, encoded data (code stream) in which temporary data are embedded are produced, and the COM data are rewritten by the correct data. By doing so, the need to employ a COM-data buffer memory for storing a very large amount of additional information can be eliminated, and the size of the apparatus can be made smaller.

If the data amount of the additional information produced by the application in use is smaller than the largest possible data amount that the register 20 of the buffer circuit 14 can store, the data stored in the register 20 are used as the COM data, and the data correction unit 16 does not carry out the later data rewrite. Thus, the formation of encoded data (code stream) can be swiftly completed.

The image processing apparatus A may be applied to a digital still camera, the recorder in a digital copying machine, a monitoring camera, a digital video storage device, a digital video camera, and the like.

### (6) Other Embodiments

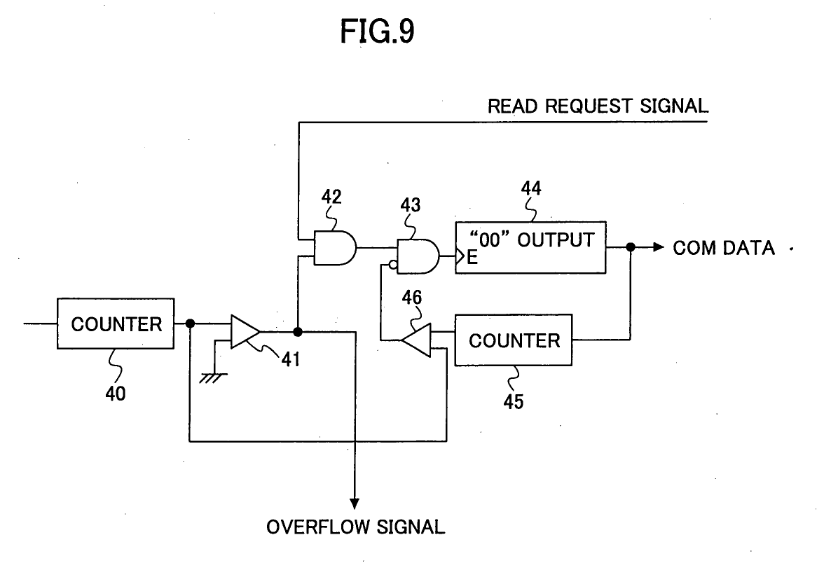

To increase the processing speed, it is preferable to employ a COM-data buffer memory that can store a large amount of data (like the register 20 of the COM buffer circuit 14 of the image processing apparatus A) to maximally avoid data rewrite. To reduce the size of the apparatus, however, it is possible to eliminate the COM-data buffer memory from the COM buffer circuit 14, and to use COM data made up only of temporary data when the data producing unit 15 produces encoded data (code stream). Accordingly, all the data can be rewritten by the correct data in the data correction unit 16. In such a case, a COM buffer circuit 14′ shown in FIG. 9 is employed instead of the COM buffer circuit 14. The structure of the data correction unit 16 and the operation performed by the CPU 1 do not need to be changed.

Referring now to FIG. 9, the structure and the operation of the COM buffer circuit 14′ will be described. The data of additional information produced by the application are first input to a counter 40 via the data bus 3. The count value of the counter 40 is input to one of the signal input terminals of a comparator 41 and one of the signal input terminals of a comparator 46. The other one of the signal input terminals of the comparator 41 is grounded. The counter 41 outputs a high-level overflow signal to the CPU 1 at the same time as outputting a count value. The high-level overflow signal is also input into one of the signal input terminals of a 2-input AND gate 42. A data read request signal is input from the data producing unit 15 into the other one of the signal input terminals of the AND gate 42. In response to the high-level overflow signal and the high-level data read request signal, the AND gate 42 outputs a high-level signal to one of the signal input terminals of a 2-input AND gate 43. If the output of the comparator 46 is at the low level, the AND gate 43 outputs a high-level signal to the enable terminal of a “00” output register 44. Upon receipt of the high-level signal input to the enable terminal, the “00” output register 44 repeatedly outputs “00”. A counter 45 counts the number of “00”s output from the “00” output register 44, and outputs the count value to the comparator 46. If the number of output “00”s is the same as the count value of the counter 40, the comparator 46 outputs a high-level signal, switches the output of the AND gate 43 to the low level, and stops the operation of the “00” output register 44.

With the COM buffer circuit 14′, the COM-data buffer memory can be completely eliminated from the image processing apparatus A, and circuit size can be greatly reduced.

It should be noted that the present invention is not limited to the embodiments specifically disclosed above, but other variations and modifications may be made without departing from the scope of the present invention.

The present application is based on Japanese priority application No. 2002-187547 filed on Jun. 27, 2002 with the Japanese Patent Office, the entire contents of that are hereby incorporated by reference.

1. An image processing apparatus that produces data having encoded data of an image and additional information added to the encoded data, comprising:
a data processing unit that produces data having a data write area added for writing data of a desired amount of additional information at a predetermined spot in the encoded data of the image; and
a data correction unit that writes the data of the additional information in the data write area in the data produced by the data processing unit.

2. The image processing apparatus as claimed in claim 1, further comprising a buffer memory for storing the additional information,
wherein:
the data processing unit, when the data amount of the additional information to be added to the encoded data exceeds the capacity of the buffer memory, produces the data having the data write area for writing the data of the additional information at the predetermined spot in the encoded data of the image, and, when the data amount of the additional information to be added to the encoded data is within the capacity of the buffer memory, temporarily stores the data of the additional information in the buffer memory, and then produces data having the data of the additional information stored in the buffer memory at the predetermined spot in the encoded data of the image; and
the data correction unit, when the data amount of the additional information to be added to the encoded data exceeds the capacity of the buffer memory, writes the data of the additional information in the data write area in the data produced by the data processing unit, and, when the data amount of the additional information to be added to the encoded data is within the capacity of the buffer memory, outputs the data produced by the data processing unit without any correction.

3. An image processing method of producing data having encoded data of an image and additional information added to the encoded data, the method comprising the steps of:
producing data having a data write area for writing the data of a desired amount of additional information at a predetermined spot in the encoded data of the image; and
performing data correction by writing the data of the additional information in the data write area in the data produced in data producing step.

4. The image processing method as claimed in claim 3, wherein:
the data producing step includes, when the data amount of the additional information to be added to the encoded data exceeds the capacity of a buffer memory employed for storing the data of the additional information, producing the data having the data write area for writing the data of the additional information at the predetermined spot in the encoded data of the image, and, when the data amount of the additional information to be added to the encoded data is within the capacity of the buffer memory, temporarily storing the data of the additional information in the buffer memory, and then producing data including the data of the additional information stored in the buffer memory at the predetermined spot in the encoded data of the image; and
the data correcting step includes, when the data amount of the additional information to be added to the encoded data exceeds the capacity of the buffer memory, writing the data of the additional information in the data write area in the data produced in the data producing step, and, when the data amount of the additional information to be added to the encoded data is within the capacity of the buffer memory, outputting the data produced in the data producing step without any correction.
